(19) United States
(12) Patent Application Publication
(10) Pub. No.: US 2017/0353056 A1
(43) Pub. Date: Dec. 7, 2017

(54) ELECTROMAGNETIC RESONANT COUPLER INCLUDING INPUT LINE, FIRST RESONANCE LINE, SECOND RESONANCE LINE, OUTPUT LINE, AND COUPLING LINE, AND TRANSMISSION APPARATUS INCLUDING THE ELECTROMAGNETIC RESONANT COUPLER

(71) Applicant: Panasonic Corporation, Osaka (JP)

(72) Inventors: YASUFUMI KAWAI, Osaka (JP); OSAMU TABATA, Osaka (JP)

(21) Appl. No.: 15/601,976

(22) Filed: May 22, 2017

(30) Foreign Application Priority Data
Jun. 2, 2016 (JP) 2016-111379

(51) Int. Cl. H02J 50/12; H03H 7/01; H01F 27/28; H01Q 1/24; H01F 38/14; H04B 5/00

(52) U.S. Cl. CPC H02J 50/12; H01Q 1/248; H01F 38/14; H03H 7/0115; H01F 27/2804; H01F 2027/2809; H04B 5/005

(57) ABSTRACT

An electromagnetic resonant coupler includes an input line to which a transmission signal is input; a first resonance line connected to the input line; a second resonance line opposing the first resonance line, the second resonance line undergoing resonant coupling with the first resonance line to thus wirelessly transmit the transmission signal between the first resonance line and the second resonance line; an output line connected to the second resonance line, the transmission signal being output through the output line; a coupling line that electromagnetically couples with at least one selected from the group consisting of the first resonance line and the second resonance line; and a terminator connected to one end of the coupling line.

### BACKGROUND

### 1. Technical Field

The present disclosure relates to an electromagnetic resonant coupler and a transmission apparatus including the electromagnetic resonant coupler.

### 2. Description of the Related Art

In a variety of electrical apparatuses, there is a demand that a signal be transmitted while electrical isolation is secured between circuits. Drive-by-Microwave Technology that uses an electromagnetic resonant coupler is being proposed as a transmission system that enables simultaneous and isolated transmission of an electric signal and power (see, for example, Japanese Unexamined Patent Application Publication No. 2008-067012).

### SUMMARY

In one general aspect, the techniques disclosed here feature an electromagnetic resonant coupler that includes an input line to which a transmission signal is input; a first resonance line connected to the input line; a second resonance line opposing the first resonance line, the second resonance line undergoing resonant coupling with the first resonance line to thus wirelessly transmit the transmission signal between the first resonance line and the second resonance line; an output line connected to the second resonance line, the transmission signal being output through the output line; a coupling line that electromagnetically couples with at least one selected from the group consisting of the first resonance line and the second resonance line; and a terminator connected to one end of the coupling line.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates temperature characteristics of an isolating transmission apparatus;

FIG. 2 is a schematic diagram illustrating a configuration of a directional coupler;

FIG. 3 is an exploded perspective view of an electromagnetic resonant coupler according to a first embodiment;

FIG. 4 is a sectional view of the electromagnetic resonant coupler according to the first embodiment;

FIG. 5 is a perspective view illustrating a wiring structure of the electromagnetic resonant coupler according to the first embodiment;

FIG. 6 is a top view illustrating a wiring structure of a first resonator and a coupling line included in the electromagnetic resonant coupler according to the first embodiment;

FIG. 7 is a schematic diagram for describing an operation of the electromagnetic resonant coupler according to the first embodiment;

FIG. 8 illustrates transmission characteristics of an electromagnetic resonant coupler according to a comparative example;

FIG. 9 illustrates transmission characteristics of the electromagnetic resonant coupler according to the first embodiment;

FIG. 10 is a perspective view illustrating a wiring structure of an electromagnetic resonant coupler according to a second embodiment;

FIG. 11 is a top view illustrating a wiring structure of a first resonator and a coupling line included in the electromagnetic resonant coupler according to the second embodiment;

FIG. 12 is a perspective view of a transmission apparatus;

FIG. 13 illustrates a circuit configuration of the transmission apparatus;

FIG. 14 illustrates a circuit configuration of a detection circuit that includes a double voltage rectifier circuit;

FIG. 15 is a block diagram of a transmission apparatus that includes a controller;

FIG. 16 is a block diagram of a transmission apparatus that includes a controller and an amplifier that amplifies a detection signal;

FIG. 17 is a block diagram of a transmission apparatus that includes a controller and an amplifier that amplifies a detection wave;

FIG. 18 illustrates a circuit configuration of a transmission apparatus that includes three electromagnetic resonant couplers; and

FIG. 19 is a top view illustrating a wiring structure of a first resonator and a coupling line included in an electromagnetic resonant coupler according to a modification of the first embodiment.

### DETAILED DESCRIPTION

### Underlying Knowledge Forming Basis of the Present Disclosure

In a variety of electrical apparatuses, there is a demand that a signal be transmitted while electrical isolation is secured between circuits. For example, when an electronic apparatus that includes a high-voltage circuit and a low-voltage circuit is put into operation, the ground loop between the circuits may be cut off in order to prevent a malfunction or a failure of the low-voltage circuit. In other words, the circuits may be isolated from each other. Such a configuration can prevent an excess voltage from being applied to the low-voltage circuit from the high-voltage circuit when the high-voltage circuit and the low-voltage circuit become electrically connected to each other.

Specifically, for example, a case in which a motor driving circuit that operates at a high voltage of several hundred volts is controlled by a microcomputer, a semiconductor integrated circuit, or the like can be considered. When a high voltage with which the motor driving circuit deals is applied to the microcomputer, the semiconductor integrated circuit, or the like that operates at a low voltage, a malfunction or a failure occurs. In order to suppress an occurrence of such a malfunction or a failure, the microcomputer, the semiconductor integrated circuit, or the like is isolated from the motor driving circuit.

A photocoupler is known as a device that transmits a signal while securing isolation between circuits. A photocoupler is a package into which a light-emitting element and a light-receiving element are integrated, and the light-emitting element and the light-receiving element are electrically isolated from each other inside the package member. A photocoupler converts an input electric signal to an optical signal with a light-emitting element, detects the converted optical signal with a light-receiving element, converts the optical signal back to an electric signal, and outputs the electric signal.

In recent years, an isolating transmission apparatus that includes an electromagnetic resonant coupler serving as an isolation device is being proposed (see, for example, Japanese Unexamined Patent Application Publication No. 2008-067012). An isolating transmission apparatus that includes an electromagnetic resonant coupler serving as an isolation device modulates a high-frequency signal with a transmission circuit in accordance with an input signal and transmits, in isolation, a modulation signal, which is the modulated high-frequency signal, to a reception circuit with the electromagnetic resonant coupler. The isolating transmission apparatus then demodulates the modulation signal with a rectifier circuit included in the reception circuit.

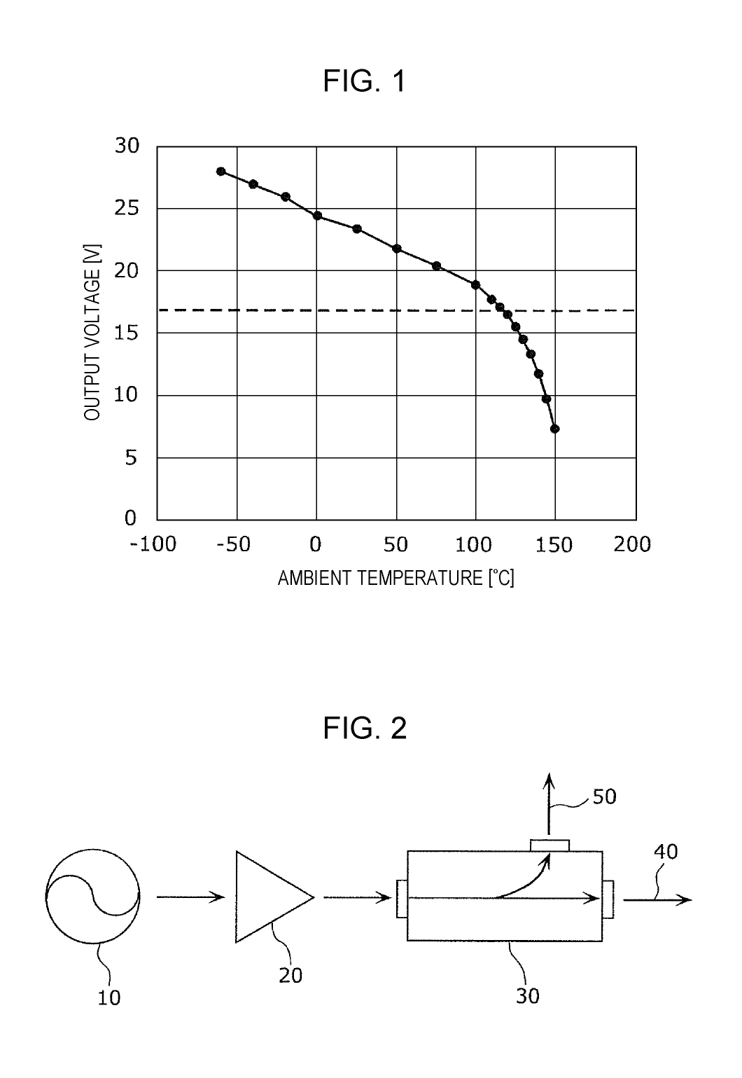

The transmission circuit includes an embedded semiconductor element and thus typically has such temperature characteristics as illustrated in FIG. 1. FIG. 1 illustrates the temperature characteristics of the isolating transmission apparatus. In FIG. 1, the prescribed value of the output voltage is indicated by the dashed line.

As illustrated in FIG. 1, the output voltage output from the isolating transmission apparatus decreases as the temperature increases. Such characteristics are due to that the modulation signal generated and output by the transmission circuit varies depending on the ambient temperature. An output voltage output from the isolating transmission apparatus when the ambient temperature is low is higher than the prescribed value of the output voltage, whereas an output voltage output from the isolating transmission apparatus when the ambient temperature is high is lower than the prescribed value of the output voltage. However, it is desirable that the isolating transmission apparatus output a constant output voltage regardless of the ambient temperature.

One of the known typical techniques for keeping the output voltage of an isolating transmission apparatus constant is to carry out feedback control by monitoring the output voltage of a transmission circuit (see, for example, Japanese Unexamined Patent Application Publication No. 2012-257421). However, when an electromagnetic resonant coupler, a transmission circuit, and a reception circuit are integrated into a package, the output voltage of the transmission circuit is not output to the outside of the package member. Therefore, it is difficult to monitor the output voltage of the transmission circuit.

A technique in which a directional coupler is used is known as a typical technique for monitoring a high-frequency signal. FIG. 2 is a schematic diagram illustrating a configuration of a directional coupler. As illustrated in FIG. 2, a directional coupler 30 divides a high-frequency signal that has been generated by an oscillator 10 and output from an amplifier 20 into an output signal 40 and a monitor signal 50. However, the directional coupler 30 typically uses a transmission line having a length of one-quarter the wavelength X of the high-frequency signal, which thus often leads to an increase in size. Therefore, it is often difficult to embed a directional coupler into an isolating transmission apparatus.

Accordingly, an electromagnetic resonant coupler according to an aspect of the present disclosure includes an input line to which a transmission signal is input; a first resonance line connected to the input line; a second resonance line opposing the first resonance line, the second resonance line undergoing resonant coupling with the first resonance line to thus wirelessly transmit the transmission signal between the first resonance line and the second resonance line; an output line connected to the second resonance line, the transmission signal being output through the output line; a coupling line that electromagnetically couples with at least one selected from the group consisting of the first resonance line and the second resonance line; and a terminator connected to one end of the coupling line.

This configuration makes it possible to obtain a detection wave corresponding to the transmission signal through the coupling line. In other words, the transmission signal can be monitored with ease with the coupling line without a complex device or the like.

In addition, as the terminator is connected to the one end of the coupling line, a detection wave can be obtained through another end of the coupling line.

In the electromagnetic resonant coupler according to the aspect of the present disclosure, the first resonance line and the coupling line may be disposed in a plane, the second resonance line may oppose the first resonance line in a direction intersecting with the plane, and the coupling line may be disposed along a portion of the first resonance line with a gap provided between the coupling line and the portion of the first resonance line to thus couple with the first resonance line.

This configuration makes it possible to obtain a detection wave through the coupling line that undergoes resonant coupling with the first resonance line.

In the electromagnetic resonant coupler according to the aspect of the present disclosure, the first resonance line may have an annular shape with a portion of the annular shape being open, and the coupling line may be disposed inside the first resonance line in the plane.

This configuration makes it possible to dispose the coupling line without increasing the area dedicated for wiring.

In the electromagnetic resonant coupler according to the aspect of the present disclosure, the first resonance line may have an annular shape with a portion of the annular shape being open, and the coupling line may be disposed outside the first resonance line in the plane.

This configuration increases the degree of freedom in the wiring gap between the coupling line and the first resonance line, which thus facilitates the adjustment of the degree of coupling.

A transmission apparatus according to an aspect of the present disclosure includes an electromagnetic resonant coupler that includes an input line to which a transmission signal is input, a first resonance line connected to the input line, a second resonance line opposing the first resonance line, the second resonance line undergoing resonant coupling with the first resonance line to thus wirelessly transmit the transmission signal between the first resonance line and the second resonance line, an output line connected to the second resonance line, the transmission signal being output through the output line, a coupling line that electromagnetically couples with at least one selected from the group consisting of the first resonance line and the second resonance line and that outputs a detection wave corresponding to the transmission signal, and a terminator connected to one end of the coupling line; a transmission circuit that inputs the transmission signal to the input line; and a detection circuit connected to another end of the coupling line, the detection circuit generating a detection signal by using the detection wave and outputting the detection signal.

In this manner, the transmission apparatus can output the detection signal corresponding to the transmission signal. Such a detection signal makes it possible to monitor the transmission signal with ease.

The transmission apparatus according to the aspect of the present disclosure may further include a controller that controls the transmission circuit on the basis of the detection signal to thus adjust at least one selected from the group consisting of an amplitude of the transmission signal and a frequency of the transmission signal.

In this manner, as the transmission circuit is controlled in accordance with the detection signal, a fluctuation in the amplitude of the transmission signal is suppressed. For example, the control is possible that brings the signal level of the signal output from the transmission apparatus close to being constant regardless of the ambient temperature of the transmission apparatus.

In the transmission apparatus according to the aspect of the present disclosure, the transmission circuit may further include an amplifier that adjusts the amplitude of the transmission signal, and the controller may control the amplifier on the basis of the detection signal to thus adjust the amplitude of the transmission signal.

In this manner, as the amplifier is controlled in accordance with the detection signal, a fluctuation in the amplitude of the transmission signal is suppressed. For example, the control is possible that brings the signal level of the signal output from the transmission apparatus close to being constant regardless of the ambient temperature of the transmission apparatus.

In the transmission apparatus according to the aspect of the present disclosure, the detection circuit may include a rectenna circuit.

This configuration enables the detection circuit to generate the detection signal by using the rectenna circuit.

In the transmission apparatus according to the aspect of the present disclosure, the detection circuit may include a double voltage rectifier circuit.

This configuration enables the detection circuit to generate the detection signal by using the double voltage rectifier circuit.

The transmission apparatus according to the aspect of the present disclosure may further include an amplifier that amplifies the detection wave and outputs the detection wave to the detection circuit.

This configuration enables the transmission apparatus to amplify the detection wave.

The transmission apparatus according to the aspect of the present disclosure may further include an amplifier that amplifies the detection signal output by the detection circuit.

This configuration enables the transmission apparatus to amplify the detection signal.

The transmission apparatus according to the aspect of the present disclosure may further include a package member that seals the electromagnetic resonant coupler, the transmission circuit, and the detection circuit; and a terminal that is partially exposed through the package member, the detection signal being output through the terminal.

This configuration makes it possible to monitor the detection signal with ease through the terminal.

In the present disclosure, all or a part of any of circuit, unit, device, part or portion, or any of functional blocks in the block diagrams may be implemented as one or more of electronic circuits including, but not limited to, a semiconductor device, a semiconductor integrated circuit (IC) or a large scale integration (LSI). The LSI or IC can be integrated into one chip, or also can be a combination of plural chips. For example, functional blocks other than a memory may be integrated into one chip. The name used here is LSI or IC, but it may also be called system LSI, very large scale integration (VLSI), or ultra large scale integration (ULSI) depending on the degree of integration. A field programmable gate array (FPGA) that can be programmed after manufacturing an LSI or a reconfigurable logic device that allows reconfiguration of the connection or setup of circuit cells inside the LSI can be used for the same purpose.

Further, it is also possible that all or a part of the functions or operations of the circuit, unit, device, part or portion are implemented by executing software. In such a case, the software is recorded on one or more non-transitory recording media such as a read-only memory (ROM), an optical disk, or a hard disk drive, and when the software is executed by a processor, the software causes the processor together with peripheral devices to execute the functions specified in the software. A system or apparatus may include such one or more non-transitory recording media on which the software is recorded and a processor together with necessary hardware devices such as an interface.

Hereinafter, embodiments will be described in detail with reference to the drawings. It is to be noted that the embodiments described hereinafter merely illustrate general or specific examples. The numerical values, the shapes, the materials, the constituent elements, the arrangement and positions of the constituent elements, the connection modes of the constituent elements, and so forth indicated in the embodiments hereinafter are examples and are not intended to limit the present disclosure. In addition, among the constituent elements described in the embodiments hereinafter, a constituent element that is not described in an independent claim indicating the broadest concept is described as an optional constituent element.

Furthermore, the drawings are schematic diagrams and do not necessarily provide the exact depiction. In the drawings, configurations that are substantially identical are given identical reference characters, and duplicate descriptions thereof may be omitted or simplified.

### First Embodiment

Overall Structure of Electromagnetic Resonant coupler According to First Embodiment

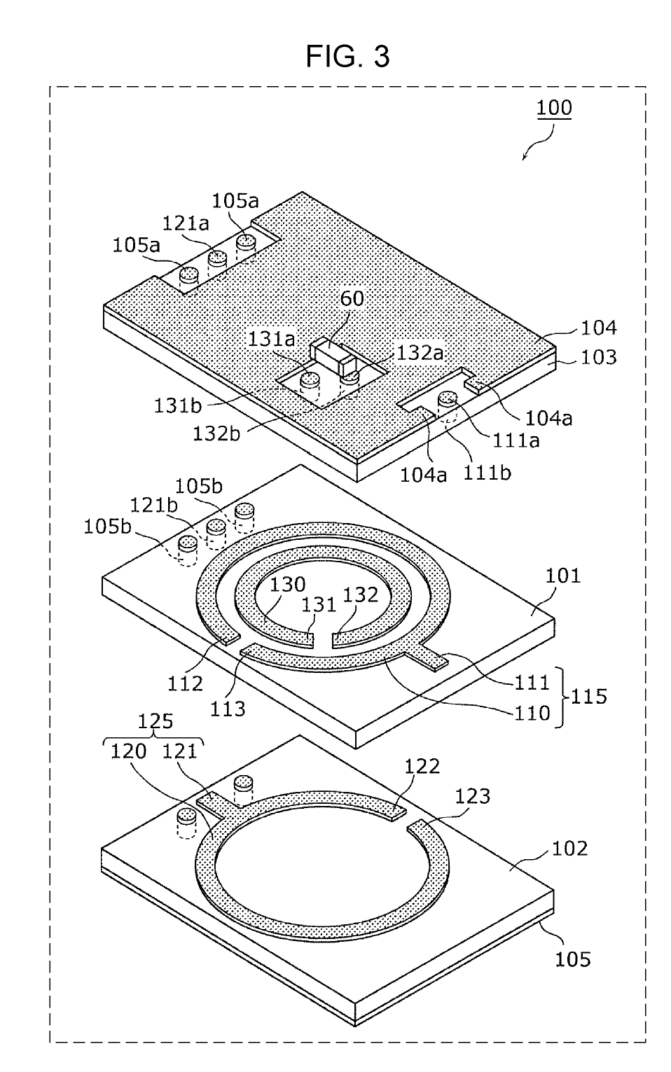

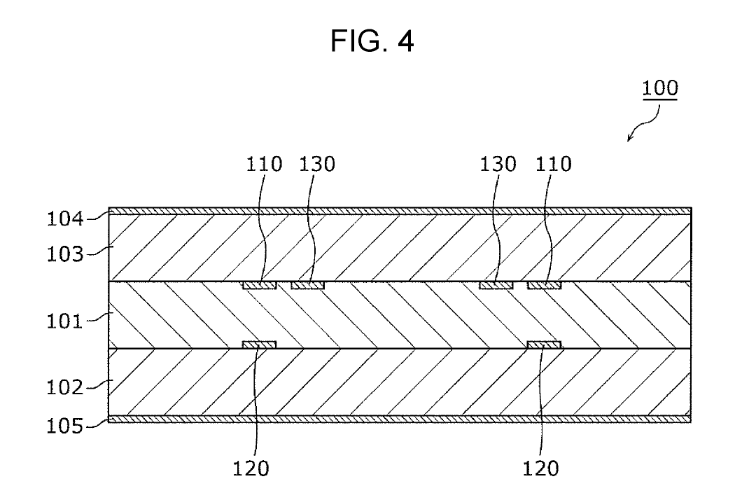

Hereinafter, an overall structure of an electromagnetic resonant coupler according to a first embodiment will be described. FIG. 3 is an exploded perspective view of the electromagnetic resonant coupler according to the first embodiment. FIG. 4 is a sectional view of the electromagnetic resonant coupler according to the first embodiment. FIG. 4 is a sectional view of the electromagnetic resonant coupler according to the first embodiment taken along a plane containing a diagonal line of a dielectric layer.

An electromagnetic resonant coupler 100 includes a first resonator 115 and a second resonator 125, which are in electromagnetic resonant coupling, and wirelessly transmits a signal to be transmitted (hereinafter, referred to as a transmission signal) with the use of the first resonator 115 and the second resonator 125. A transmission signal can be rephrased as a modulated high-frequency signal. For example, upon a transmission signal being input to an input terminal 111a by a transmission circuit, this transmission signal is wirelessly transmitted from the first resonator 115 to the second resonator 125 and output through an output terminal 121a. The output transmission signal is demodulated by a reception circuit, for example. A high-frequency signal is a signal with a frequency of no lower than 1 MHz, for example.

The electromagnetic resonant coupler 100 also operates as a so-called directional coupler and includes a coupling line 130 that outputs a detection wave for monitoring a transmission signal as the electromagnetic resonant coupler 100 has a prescribed degree of coupling.

The degree of coupling of the electromagnetic resonant coupler 100, which operates as a directional coupler, is determined by the ratio between a transmission signal input to the first resonator 115 and a detection wave output from the coupling line 130. The insertion loss of the electromagnetic resonant coupler 100, which operates as a directional coupler, is determined by the ratio between a transmission signal input to the first resonator 115 and a transmission signal output from the second resonator 125.

As illustrated in FIGS. 3 and 4, the electromagnetic resonant coupler 100 has a multilayer structure in which three dielectric layers including a dielectric layer 101, a dielectric layer 102, and a dielectric layer 103 are stacked on each other. Sapphire substrates, for example, are used for the dielectric layers 101, 102, and 103. The dielectric layers 101, 102, and 103 may be formed by a polyphenylene ether resin (PPE resin) filled with an inorganic filler having a high dielectric constant.

The first resonator 115 and the coupling line 130 are formed in a plane on the upper surface of the dielectric layer 101. The first resonator 115 includes a first resonance line 110 and a linear input line 111 electrically connected to the first resonance line 110. The first resonator 115 may instead be formed on the lower surface of the dielectric layer 103.

The dielectric layer 102 is disposed such that the lower surface of the dielectric layer 101 is on the upper surface of the dielectric layer 102. The second resonator 125 is formed in a plane on the upper surface of the dielectric layer 102. The second resonator 125 includes a second resonance line 120 and a linear output line 121 electrically connected to the second resonance line 120. A second ground shield 105 is provided on substantially the entire lower surface of the dielectric layer 102.

The dielectric layer 103 is disposed such that the lower surface of the dielectric layer 103 is on the upper surface of the dielectric layer 101. The input terminal 111a, the output terminal 121a, a terminal 131a, a terminal 132a, a first ground shield 104, and two receiver-side ground terminals 105a are formed in a plane on the upper surface of the dielectric layer 103. The first ground shield 104 includes two transmitter-side ground terminals 104a.

In this manner, the first resonator 115, the second resonator 125, the first ground shield 104, and the second ground shield 105 are disposed in mutually different planes. The first resonator 115, the second resonator 125, the first ground shield 104, the second ground shield 105, and the terminals (the input terminal 111a and so on) are formed of metal such as copper.

The input terminal 111a is disposed between the two transmitter-side ground terminals 104a. The input terminal 111a and the two transmitter-side ground terminals 104a constitute a ground-signal-ground (G-S-G) pad. The input terminal 111a and the two transmitter-side ground terminals 104a are used to electrically connect the transmission circuit to the first resonator 115.

The output terminal 121a is disposed between the two receiver-side ground terminals 105a. The output terminal 121a and the two receiver-side ground terminals 105a constitute a ground-signal-ground (G-S-G) pad. The output terminal 121a and the two receiver-side ground terminal 105a are used to electrically connect the reception circuit to the second resonator 125.

The terminals 131a and 132a are used to monitor the transmission signal transmitted by the electromagnetic resonant coupler 100. The terminal 132a is electrically connected to the first ground shield 104 with a terminator 60 provided therebetween. The terminator 60, for example, is a 50-Ω chip resistor, but another type of resistor may instead be used as the terminator 60. For example, a so-called component resistor, a metal resistor buried in a semiconductor chip, a resistor formed by an epitaxial layer, or the like may be used as the terminator 60.

The electromagnetic resonant coupler 100 further includes a via that penetrates at least one of the dielectric layers 101, 102, and 103. Hereinafter, vias included in the electromagnetic resonant coupler 100 will be described with reference to FIG. 3. Metal, such as copper, is used for the vias.

A first via 111b is a conductive via structure that penetrates the dielectric layer 103 at one end portion of the electromagnetic resonant coupler 100. The first via 111b electrically connects the input line 111 to the input terminal 111a.

A second via 121b is a conductive via structure that penetrates the dielectric layers 101 and 103 at another end portion of the electromagnetic resonant coupler 100. The second via 121b electrically connects the output line 121 to the output terminal 121a. The second via 121b is located between two third vias 105b.

The third vias 105b are conductive via structures that penetrate the dielectric layers 101, 102, and 103 at the other end portion of the electromagnetic resonant coupler 100. The third vias 105b electrically connect the second ground shield 105 to the receiver-side ground terminals 105a. The electromagnetic resonant coupler 100 includes two third vias 105b. The second via 121b is located between the two third vias 105b.

A fourth via 131b is a conductive via structure that penetrates the dielectric layer 103. The fourth via 131b electrically connects an end portion 131 of the coupling line 130 to the terminal 131a.

A fifth via 132b is a conductive via structure that penetrates the dielectric layer 103. The fifth via 132b electrically connects an end portion 132 of the coupling line 130 to the terminal 132a.

### Wiring Structure of Electromagnetic Resonant Coupler According to First Embodiment

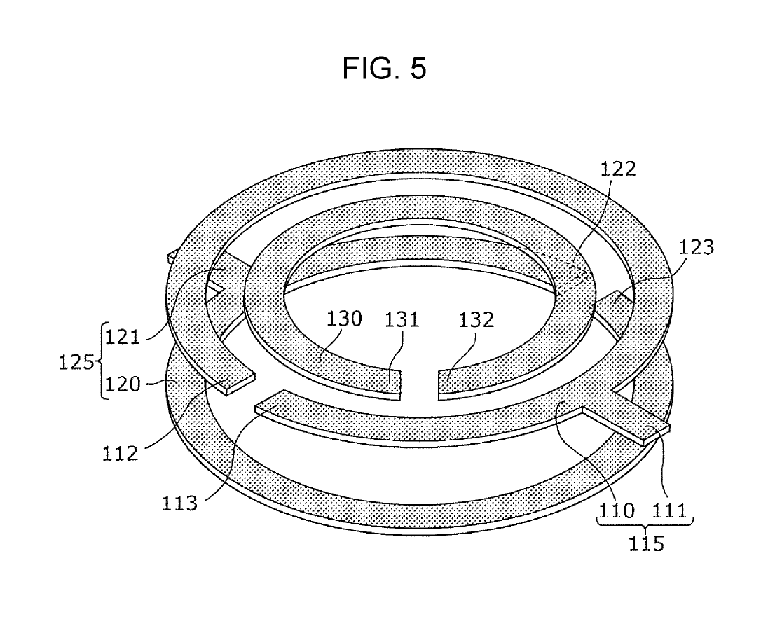

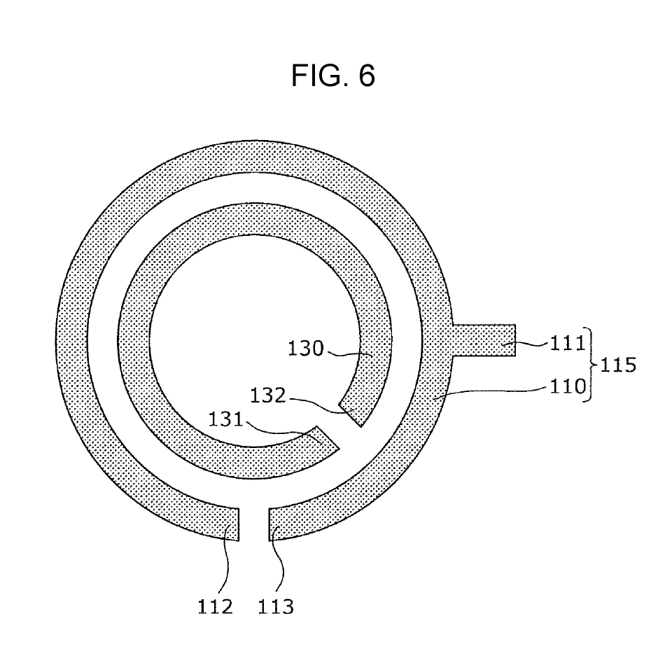

Next, the wiring structure of the electromagnetic resonant coupler 100 will be described in further detail with reference to FIGS. 3, 5, and 6. FIG. 5 is a perspective view illustrating the wiring structure of the electromagnetic resonant coupler 100. FIG. 6 is a top view illustrating the wiring structure of the first resonator 115 and the coupling line 130 included in the electromagnetic resonant coupler 100.

The shape of the first resonator 115 will be described first. The first resonator 115 includes the first resonance line 110 and the input line 111 electrically connected to the first resonance line 110.

The first resonance line 110 is an annular line with a portion thereof being open at an opening portion. The first resonance line 110 serves as an antenna for a transmission signal. The first resonance line 110 is an annular line with one end portion 112 and another end portion 113 being located close to each other with a predetermined gap provided therebetween. The term “close to” as used herein means that the items are provided in close proximity to each other but are not in contact with each other.

It suffices that the first resonance line 110 be annular with a portion thereof being open. The term “annular” means that a given shape is closed if an opening portion is not provided. In other words, a shape that partially winds is also regarded as an annular shape. Examples of such annular shapes include a ring shape and a racetrack-like shape. An annular shape with a polygonal outline and an elliptical shape are also regarded as annular shapes. The line length of the first resonance line 110 is one-half the wavelength of the transmission signal. The line length of the second resonance line 120 can be made one-quarter the wavelength of the transmission signal by connecting one of the end portions 112 and 113 to the first ground shield 104 with a via or the like provided therebetween.

The input line 111 is a linear line connected at one end to the first resonance line 110, and a transmission signal is input to another end of the input line 111 through the input terminal 111a and the first via 111b. The input line 111 is connected, for example, at a position that is one-quarter the line length of the first resonance line 110 from an end included in the end portion 113 of the first resonance line 110. The position at which the input line 111 is connected is not particularly limited.

Although the first resonance line 110 and the input line 111 are aines with a constant line width in the first embodiment, the line width does not need to be constant. For example, the line width of the first resonance line 110 may differ from the line width of the input line 111, or the line width of the first resonance line 110 may partially vary.

Next, the shape of the second resonator 125 will be described. The second resonator 125 includes the second resonance line 120 and the output line 121 electrically connected to the second resonance line 120.

The second resonance line 120 is an annular line with a portion thereof being open at an opening portion. The second resonance line 120 serves as an antenna for a transmission signal. The second resonance line 120 is an annular line with one end portion 122 and another end portion 123 located close to each other with a predetermined gap provided therebetween. The term “close to” as used herein means that the items are provided in close proximity to each other but are not in contact with each other.

It suffices that the second resonance line 120 be annular with a portion thereof being open. The term “annular” means that a given shape is closed if an opening portion is not provided. In other words, a shape that partially winds is also regarded as an annular shape. Examples of such annular shapes include a ring shape and a racetrack-like shape. An annular shape with a polygonal outline and an elliptical shape are also regarded as annular shapes. The line length of the second resonance line 120 is one-half the wavelength of the transmission signal. The line length of the second resonance line 120 can be made one-quarter the wavelength of the transmission signal by connecting one of the end portions 122 and 123 to the second ground shield 105 with a via or the like provided therebetween.

The output terminal 121a is a linear line connected at one end to the second resonance line 120, and a transmission signal is output from another end of the output line 121 through the second via 121b and the output terminal 121a. The output line 121 is connected, for example, at a position that is one-quarter the line length of the second resonance line 120 from an end included in the end portion 122 of the second resonance line 120, but the position at which the output line 121 is connected is not particularly limited.

Although the second resonance line 120 and the output line 121 are lines with a constant line width in the first embodiment, the line width does not need to be constant. For example, the line width of the second resonance line 120 may differ from the line width of the output line 121, or the line width of the second resonance line 120 may partially vary.

Next, the shape of the coupling line 130 will be described. The coupling line 130 is an annular line with a portion thereof being open at an opening portion. The coupling line 130 can be rephrased as a line that partially constitutes a high-frequency filter. The coupling line 130 is an annular line with the one end portion 131 and the other end portion 132 located close to each other with a predetermined gap provided therebetween. The term “close to” as used herein means that the items are provided in close proximity to each other but are not in contact with each other.

It suffices that the coupling line 130 be annular with a portion thereof being open. The term “annular” means that a given shape is closed if an opening portion is not provided. In other words, a shape that partially winds is also regarded as an annular shape. Examples of such annular shapes include a ring shape and a racetrack-like shape. An annular shape with a polygonal outline and an elliptical shape are also regarded as annular shapes. The line length of the coupling line 130 is, for example, no less than 80% nor more than 120% of one-half the wavelength of the transmission signal. The line length of the coupling line 130 is often shorter than that of the first resonance line 110 in the case in which the coupling line 130 is disposed inside the first resonance line 110. In the case in which the coupling line 130 is disposed outside the first resonance line 110, the line length of the coupling line 130 may be shorter than that of the first resonance line 110 or may be equal to or longer than that of the first resonance line 110.

As illustrated in FIG. 3, the one end portion 131 of the coupling line 130 is connected to the terminal 131a with the fourth via 131 b provided therebetween, and the other end portion 132 of the coupling line 130 is connected to the terminal 132a with the fifth via 132b provided therebetween. In the first embodiment, the terminal 131a is used as a terminal for monitoring, and the terminal 132a is terminated by the 50-Ω terminator 60. It suffices that one of the terminals 131a and 132a be terminated by the 50-Ω terminator 60 and that the other one of the terminals 131a and 132a be used as a terminal for monitoring.

Although the coupling line 130 has a constant line width in the first embodiment, the line width does not need to be constant. For example, the line width of the coupling line 130 may partially vary. The line width of the coupling line 130 may differ from the line width of the first resonance line 110.

### Positional Relationship of Wires

Next, the positional relationship among the first resonator 115, the second resonator 125, and the coupling line 130 will be described. The positional relationship between the first resonator 115 and the second resonator 125 will be described first.

The first resonance line 110 in the first resonator 115 is disposed to oppose the second resonance line 120 in the second resonator 125 in the lamination direction. The dielectric layer 101 is present between the first resonance line 110 and the second resonance line 120. Therefore, the first resonance line 110 and the second resonance line 120 are not in direct contact with each other.

The outline of the first resonance line 110 substantially coincides with the outline of the second resonance line 120 when viewed in the direction perpendicular to the principal surface of the dielectric layer 101, or in other words, when viewed from above. The outline of the first resonance line 110 is defined as follows.

Suppose that the opening portion is not provided in the first resonance line 110 and that the first resonance line 110 is a closed annular line, this closed annular line has an inner-peripheral outline that defines a region enclosed by the closed annular line and an outer-peripheral outline that defines the shape of the closed annular line along with the inner-peripheral outline. Of these two outlines, the outline of the first resonance line 110 refers to the outer-peripheral outline. In other words, the inner-peripheral outline and the outer-peripheral outline define the line width of the first resonance line 110, and the outer-peripheral outline defines the area occupied by the first resonance line 110. The same definition applies to the outline of the second resonance line 120.

Specifically, in the first embodiment, the outlines of the first resonance line 110 and the second resonance line 120 correspond to the outermost shapes of the first resonance line 110 and the second resonance line 120 and are circular in shape. In this case, that the outlines coincide with each other means that the outlines substantially coincide with each other except for the portions corresponding to the opening portions.

That the outlines substantially coincide with each other means that the outlines substantially coincide with each other with taken into account a variation associated with assembling the dielectric layers 101 and 102 and a variation in the sizes of the first resonance line 110 and the second resonance line 120 that could arise in the manufacturing process. In other words, that the outlines substantially coincide with each other does not necessarily mean that the outlines completely coincide with each other.

Even in the case in which the outlines of the first resonance line 110 and the second resonance line 120 do not coincide with each other, the electromagnetic resonant coupler 100 is operable. The electromagnetic resonant coupler 100 operates more effectively when the outlines of the first resonance line 110 and the second resonance line 120 coincide with each other.

In the first embodiment, the first resonance line 110 and the second resonance line 120 are in the positional relationship of point symmetry or line symmetry when viewed from above. The first resonance line 110 and the second resonance line 120 may be in any desired positional relationship as viewed from above as long as a given positional relationship is within a range in which an electromagnetic resonance phenomenon occurs between the resonance lines.

The first resonance line 110 and the second resonance line 120 may be coaxial. Such an arrangement enhances the resonant coupling between the resonance lines and makes it possible to transmit power with high efficiency.

The distance between the first resonator 115 and the second resonator 125 in the lamination direction is no more than one-half the operation wavelength, which is the wavelength of a transmission signal. The wavelength in this case is the wavelength that takes into consideration the wavelength compaction ratio by the dielectric layer 101 in contact with the first resonator 115 and the second resonator 125. Under such a condition, it can be said that the first resonator 115 and the second resonator 125 are in electromagnetic resonant coupling in the near-field range. The distance between the first resonator 115 and the second resonator 125 in the lamination direction corresponds to the thickness of the dielectric layer 101.

The distance between the first resonator 115 and the second resonator 125 in the lamination direction is not limited to one-half the operation wavelength. Even in the case in which the distance between the first resonator 115 and the second resonator 125 in the lamination direction is greater than one-half the operation wavelength, the electromagnetic resonant coupler 100 is operable. However, the electromagnetic resonant coupler 100 operates more effectively when the distance between the first resonator 115 and the second resonator 125 in the lamination direction is no more than one-half the operation wavelength.

Next, the positional relationship between the first resonator 115 and the coupling line 130 will be described.

Similarly to the first resonance line 110, the coupling line 130 is formed on the upper surface of the dielectric layer 101. In other words, the coupling line 130 and the first resonance line 110 are disposed in the same plane. The coupling line 130 is disposed inside the first resonance line 110 along a portion of the first resonance line 110 with a predetermined gap provided between the coupling line 130 and the portion of the first resonance line 110. This configuration makes it possible to dispose the coupling line 130 without increasing the area dedicated for wiring on the dielectric layer 101. The coupling line 130 and the first resonance line 110 are not connected with a line and are not in contact with each other.

The degree of coupling between the coupling line 130 and the first resonance line 110 is determined by the gap between the coupling line 130 and the first resonance line 110, the line width of the coupling line 130, and so on.

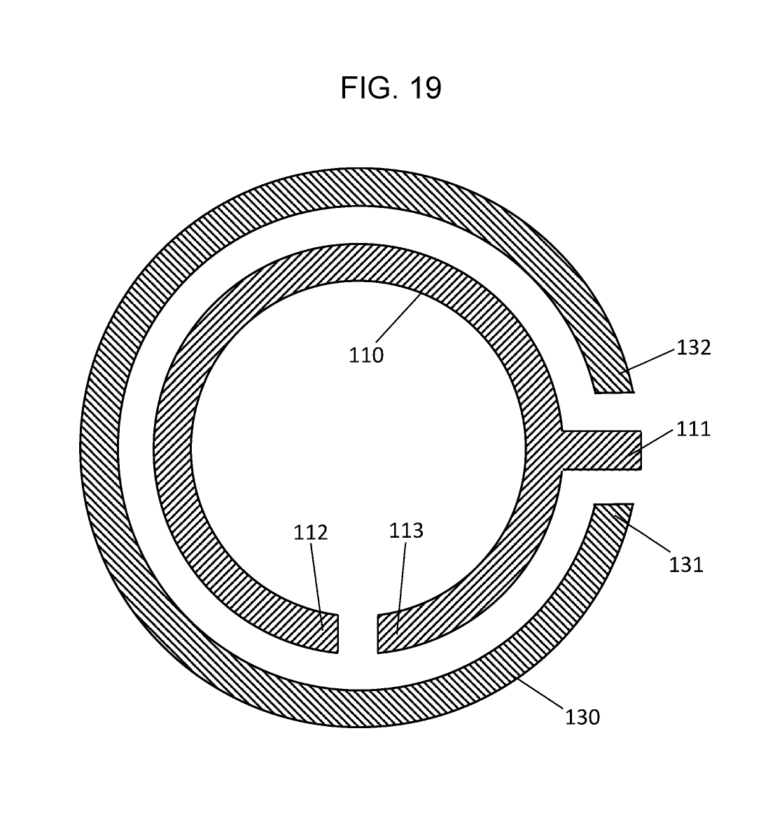

Thus, as illustrated in FIG. 19, the coupling line 130 may be disposed outside the first resonance line 110 along a portion of the first resonance line 110 with a predetermined gap provided between the coupling line 130 and the portion of the first resonance line 110. Disposing the coupling line 130 outside the first resonance line 110 increases the degree of freedom in the wiring gap between the coupling line 130 and the first resonance line 110, which thus facilitates the adjustment of the degree of coupling. For example, the degree of coupling can be increased.

In the electromagnetic resonant coupler 100, the coupling line 130 couples with the first resonance line 110, but the coupling line 130 may couple with the second resonance line 120. In this case, similarly to the second resonance line 120, the coupling line 130 is formed on the upper surface of the dielectric layer 102. In other words, the coupling line 130 and the second resonance line 120 are disposed in the same plane. The term “coupling” as used herein means electromagnetic coupling and does not mean structural coupling.

The coupling line 130 may, for example, be disposed inside the second resonance line 120 along a portion of the second resonance line 120 with a predetermined gap provided between the coupling line 130 and the portion of the second resonance line 120. The coupling line 130 may be disposed outside the second resonance line 120 along a portion of the second resonance line 120 with a predetermined gap provided between the coupling line 130 and the portion of the second resonance line 120.

### Operation of Electromagnetic Resonant Coupler

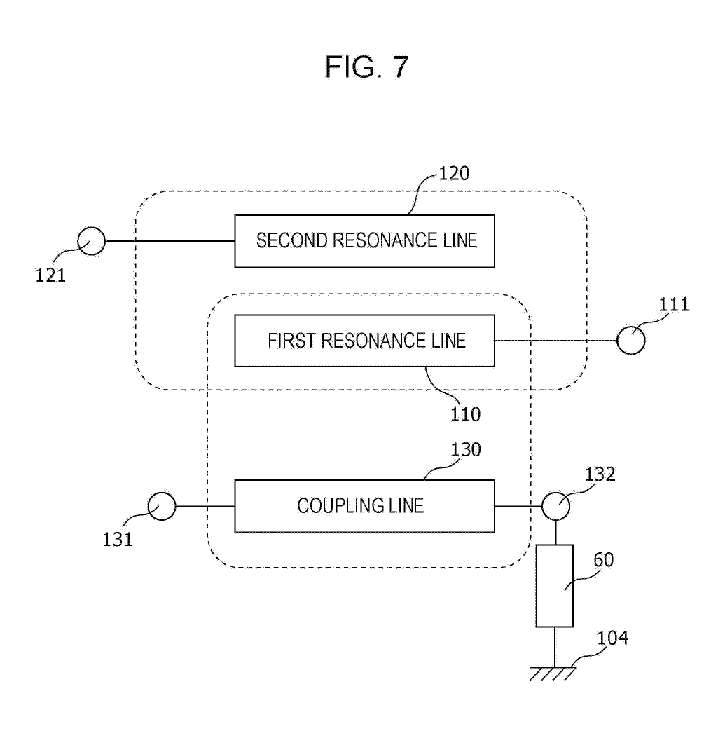

An operation of the electromagnetic resonant coupler 100 will be described with reference to FIG. 7. FIG. 7 is a schematic diagram for describing the operation of the electromagnetic resonant coupler 100.

A transmission signal input to the input line 111 is wirelessly transmitted to the second resonance line 120 from the first resonance line 110 through electromagnetic resonant coupling between the first resonance line 110 and the second resonance line 120 and is output through the output line 121.

The first resonance line 110 is shared by the second resonance line 120 and the coupling line 130. The transmission signal input to the input line 111 is also output to the terminal 131a through the end portion 131 of the coupling line 130. In other words, the terminal 131a can be used as a terminal for monitoring the transmission signal. As described above, the end portion 132 of the coupling line 130 is connected to the first ground shield 104 with the terminator 60 provided therebetween. In other words, the end portion 132 of the coupling line 130 is terminated by the terminator 60. The terminator 60 may be a constituent element of the electromagnetic resonant coupler 100 or may be separate from the electromagnetic resonant coupler 100.

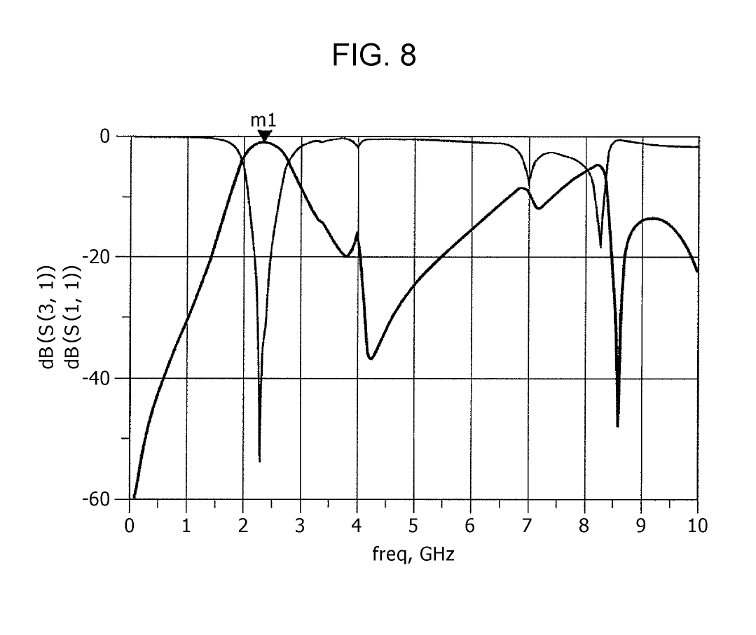

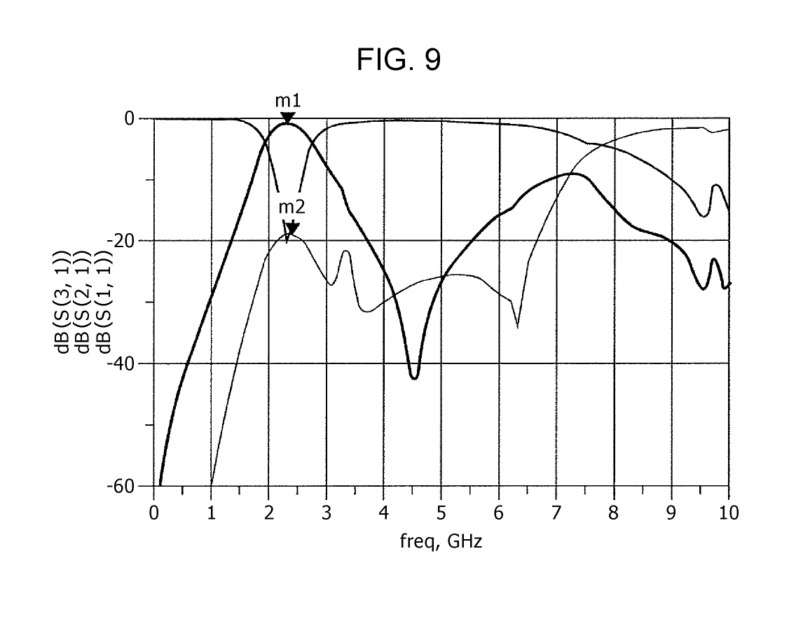

A result of simulating the transmission characteristics of the electromagnetic resonant coupler 100 that operates as described above will be described with reference to FIGS. 8 and 9. FIG. 8 illustrates the transmission characteristics of an electromagnetic resonant coupler according to a comparative example. FIG. 9 illustrates the transmission characteristics of the electromagnetic resonant coupler 100. The electromagnetic resonant coupler according to the comparative example is similar to the electromagnetic resonant coupler 100 except in that the former does not include the coupling line 130.

In the simulation, the frequency of the transmission signal is set to 2.4 GHz. The terminator 60 is set to 50Ω.

As indicated by the position of m1 in FIG. 8, the insertion loss of the electromagnetic resonant coupler according to the comparative example is 0.96 dB at 2.4 GHz. Meanwhile, as indicated by the position of m1 in FIG. 9, the insertion loss of the electromagnetic resonant coupler 100 is 1.06 dB at 2.4 GHz, which is worse than the insertion loss of the electromagnetic resonant coupler according to the comparative example although the difference is only less than 1%.

On the other hand, as indicated by the position of m2 in FIG. 9, the degree of coupling when the electromagnetic resonant coupler 100 is regarded as a directional coupler is −19 dB, which is a sufficiently large degree of coupling.

In this manner, in the electromagnetic resonant coupler 100, the transmission signal can be monitored without any additional, separate component besides the coupling line 130.

As illustrated in FIG. 9, the resonant coupling between the first resonance line 110 and the second resonance line 120 is sufficiently stronger than the resonant coupling between the first resonance line 110 and the coupling line 130.

### Advantageous Effects of First Embodiment

As described thus far, the electromagnetic resonant coupler 100 includes the input line 111 to which a transmission signal is input; the first resonance line 110 connected to the input line 111; the second resonance line 120 opposing the first resonance line 110, the second resonance line 120 undergoing resonant coupling with the first resonance line 110 to wirelessly transmit the transmission signal between the first resonance line 110 and the second resonance line 120; the output line 121 connected to the second resonance line 120, the transmission signal that has been wirelessly transmitted being output through the output line 121; and the coupling line 130 that couples with at least one of the first resonance line 110 and the second resonance line 120.

This configuration makes it possible to obtain a detection wave corresponding to the transmission signal through the coupling line 130. In other words, the transmission signal can be monitored with ease with the coupling line 130 without a complex device or the like.

The electromagnetic resonant coupler 100 may further include the terminator 60 connected to the other end portion 132 of the coupling line 130. The other end portion 132 corresponds to one end of the coupling line.

In this manner, connecting the terminator 60 to the other end portion 132 of the coupling line 130 makes it possible to obtain a detection wave through the one end portion 131 of the coupling line 130. In addition, this configuration renders it unnecessary to externally provide the terminator 60 in a transmission apparatus that will be described later.

The first resonance line 110 and the coupling line 130 may be disposed in the same plane, and the second resonance line 120 may oppose the first resonance line 110 in the direction intersecting with the stated plane. The coupling line 130 may be disposed along a portion of the first resonance line 110 with a predetermined gap provided between the coupling line 130 and the portion of the first resonance line 110 and may thus couple with the first resonance line 110.

This configuration makes it possible to obtain a detection wave through the coupling line 130 that couples with the first resonance line 110.

The first resonance line 110 may be annular with a portion thereof being open, and the coupling line 130 may be disposed inside the first resonance line 110 in the same plane.

This configuration makes it possible to dispose the coupling line 130 without increasing the area dedicated for wiring.

The first resonance line 110 may be annular with a portion thereof being open, and the coupling line 130 may be disposed outside the first resonance line 110 in the same plane.

This configuration increases the degree of freedom in the wiring gap between the coupling line 130 and the first resonance line 110, which thus facilitates the adjustment of the degree of coupling.

### Second Embodiment

### Wiring Structure of Electromagnetic Resonant Coupler According to Second Embodiment

In a second embodiment, an electromagnetic resonant coupler that can transmit, in isolation, two high-frequency signals independently from each other and that operates as a directional coupler will be described. In the second embodiment described hereinafter, the configurations aside from the wiring structures of a first resonator and a second resonator (for example, the positional relationship between the first resonator and the second resonator) are similar to those of the first embodiment, and thus descriptions of such similar configurations will be omitted.

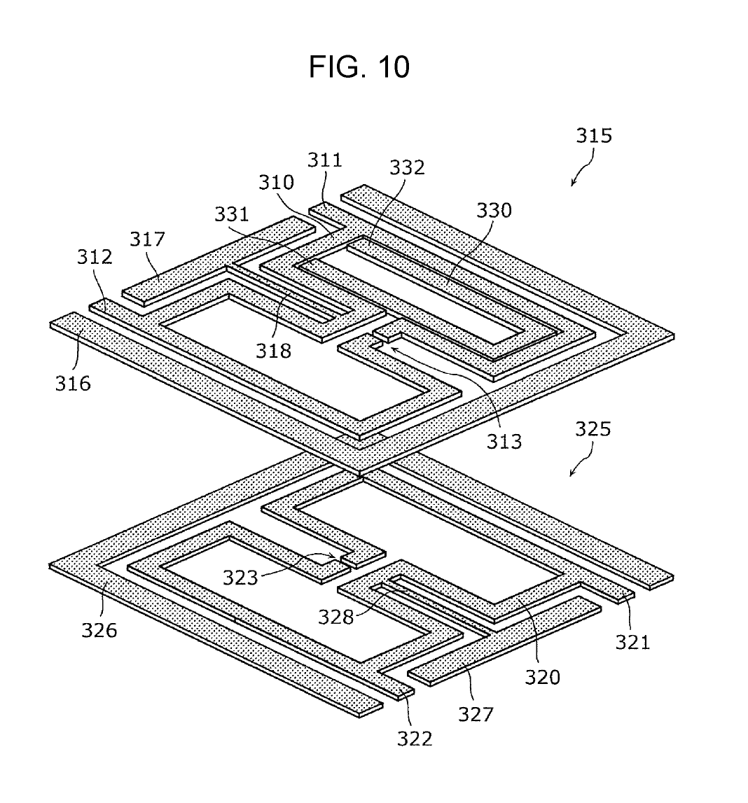

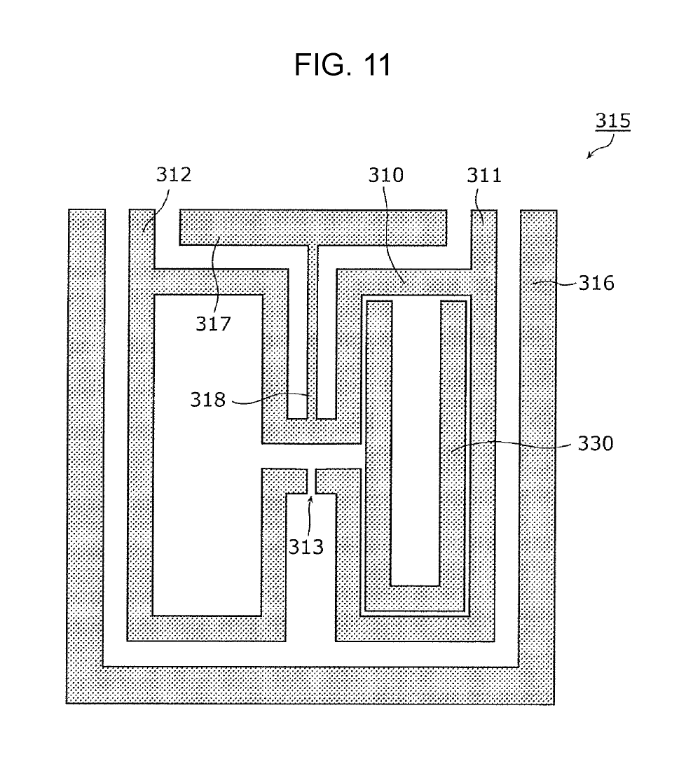

FIG. 10 is a perspective view illustrating the wiring structure of the electromagnetic resonant coupler according to the second embodiment. FIG. 11 is a top view illustrating the wiring structure of the first resonator and the coupling line included in the electromagnetic resonant coupler according to the second embodiment. The electromagnetic resonant coupler according to the second embodiment includes a first resonator 315, a second resonator 325, and a coupling line 330.

The first resonator 315 will be described first. The first resonator 315 includes a first resonance line 310, a first input line 311, a second input line 312, first ground lines 316 and 317, and a first connection line 318.

The first resonance line 310 is a modified annular line having an opening portion 313. The first resonance line 310 has two recess portions that are recessed toward the inside as viewed from above, and these two recess portions are close to each other. The opening portion 313 is provided in one of the two recess portions, and a connection portion to which one end of the linear first connection line 318 is connected is provided at the other one of the two recess portions. The connection portion is electrically connected to the first ground line 317 with the first connection line 318 provided therebetween. The first resonator 315 can be seen as two substantially rectangular annular lines being connected at the connection portion. The connection portion may be connected to the first ground shield 104 (not illustrated in FIGS. 10 and 11) with a via provided therebetween instead of being connected to the first ground line 317.

The first input line 311 is a linear line electrically connected to the first resonance line 310. Specifically, the first input line 311 is electrically connected to one of the aforementioned two substantially rectangular annular lines. A transmission signal input to the first input line 311 is output to a first output line 321 included in the second resonator 325.

The second input line 312 is a linear line electrically connected to the first resonance line 310. Specifically, the second input line 312 is electrically connected to the other one of the aforementioned two substantially rectangular annular lines. A transmission signal input to the second input line 312 is output to a second output line 322 included in the second resonator 325.

The first ground lines 316 and 317 are lines that serve as a reference potential within the first resonator 315. The first ground line 316 is bracket-shaped, and the first ground line 317 is linear. The first ground lines 316 and 317 are disposed to surround the first resonance line 310 and function as a so-called coplanar ground. The first ground line 317 is connected to another end of the first connection line 318. The first ground lines 316 and 317 do not need to be provided, and the first ground shield 104 may instead serve as a reference potential. In that case, the other end of the first connection line 318 is connected to the first ground shield 104 with a via provided therebetween.

Next, the second resonator 325 will be described. The second resonator 325 includes a second resonance line 320, the first output line 321, the second output line 322, second ground lines 326 and 327, and a second connection line 328.

The second resonance line 320 is a modified annular line having an opening portion 323. The second resonance line 320 has two recess portions that are recessed toward the inside as viewed from above, and these two recess portions are close to each other. The opening portion 323 is provided in one of the two recess portions, and a connection portion to which one end of the linear second connection line 328 is connected is provided at the other one of the two recess portions. The connection portion is electrically connected to the second ground line 327 with the second connection line 328 provided therebetween. The second resonator 325 can be seen as two substantially rectangular annular lines being connected at the connection portion. The connection portion may be connected to the second ground shield 105 (not illustrated in FIGS. 10 and 11) with a via provided therebetween instead of being connected to the second ground line 327.

The first output line 321 is a linear line electrically connected to the second resonance line 320. Specifically, the first output line 321 is electrically connected to one of the aforementioned two substantially rectangular annular lines. A transmission signal input to the first input line 311 included in the first resonator 315 is output through the first output line 321.

The second output line 322 is a linear line electrically connected to the second resonance line 320. Specifically, the second output line 322 is electrically connected to the other one of the aforementioned two substantially rectangular annular lines. A transmission signal input to the second input line 312 included in the first resonator 315 is output through the second output line 322.

The second ground lines 326 and 327 are lines that serve as a reference potential within the second resonator 325. The second ground line 326 is bracket-shaped, and the second ground line 327 is linear. The second ground lines 326 and 327 are disposed to surround the second resonance line 320 and function as a so-called coplanar ground. The second ground line 327 is connected to another end of the second connection line 328.

Next, the coupling line 330 will be described. The coupling line 330 is a bracket-shaped line. The coupling line 330 and the first resonance line 310 are disposed in the same plane.

The coupling line 330 is disposed inside the first resonance line 310 along a portion of the first resonance line 310 with a predetermined gap provided between the coupling line 330 and the portion of the first resonance line 310. To be more specific, the coupling line 330 is disposed inside and along one of the aforementioned two substantially rectangular annular lines to which the first input line 311 is connected.

Although not illustrated in FIGS. 10 and 11, one end portion 331 of the coupling line 330 is connected to a terminal for monitoring with a via provided therebetween, and another end portion 332 of the coupling line 330 is connected to a terminal terminated by the terminator 60 with a via provided therebetween.

In the electromagnetic resonant coupler having such a wiring structure, a transmission signal input to the first input line 311 can be monitored with the coupling line 330. The electromagnetic resonant coupler may further include another coupling line disposed inside and along the other one of the aforementioned substantially rectangular annular lines to which the second input line 312 is connected. In other words, the electromagnetic resonant coupler may include a plurality of coupling lines with respect to a single first resonance line 310. Such coupling lines make it possible to further monitor the transmission signal input to the second input line 312.

The coupling line 330 may undergo resonant coupling with the second resonance line 320. In other words, the coupling line 330 and the second resonance line 320 may be disposed in the same plane.

### Third Embodiment

### Structure of Transmission Apparatus According to Third Embodiment

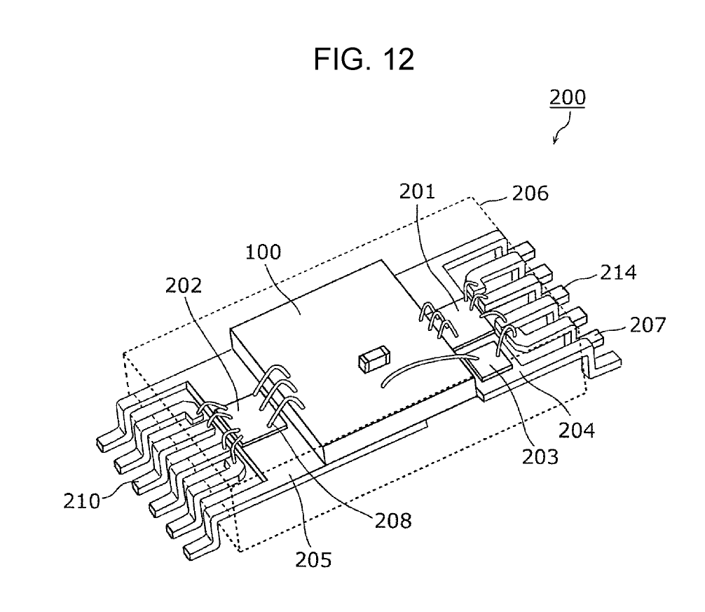

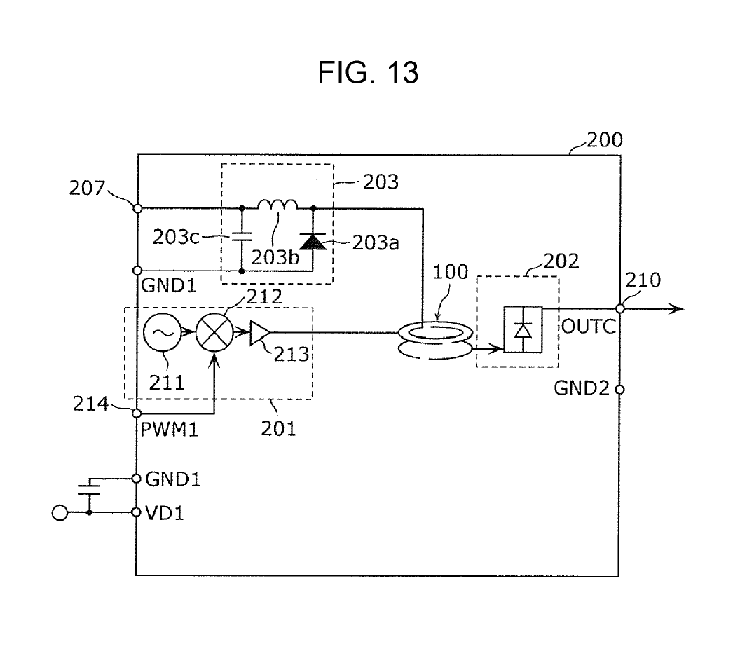

In a third embodiment, a transmission apparatus that includes the electromagnetic resonant coupler 100 will be described. FIG. 12 is a perspective view of the transmission apparatus. FIG. 13 illustrates a circuit configuration of the transmission apparatus.

As illustrated in FIGS. 12 and 13, a transmission apparatus 200 includes a transmission circuit 201, the electromagnetic resonant coupler 100, a reception circuit 202, a detection circuit 203, a first leadframe 204, a second leadframe 205, a package member 206, and terminals (for example, a terminal 207, a terminal 210, and a terminal 214). A bonding wire 208 is used to electrically connect these devices.

The package member 206 is a mold resin that seals the above constituent elements except for the terminals and is indicated by the dashed line in FIG. 12 in order to show the internal structure of the transmission apparatus 200.

The transmission circuit 201 inputs a transmission signal to the input terminal 111a included in the electromagnetic resonant coupler 100. The transmission circuit 201 is, for example, a semiconductor formed into a chip and is die-bonded on the upper surface of the first leadframe 204. As illustrated in FIG. 13, the transmission circuit 201 includes, for example, an oscillator circuit 211, a mixing circuit 212, and an amplifier 213.

The oscillator circuit 211 generates a high-frequency signal, which is a carrier wave of an input signal (for example, a binary digital signal) input to the terminal 214. A high-frequency signal as used herein means a signal having a frequency higher than that of a signal input to the terminal 214 and is specifically a signal having a frequency of no lower than 1 MHz.

The mixing circuit 212 modulates the high-frequency signal output by the oscillator circuit 211 in accordance with the input signal input to the terminal 214 to thus generate a transmission signal. The amplifier 213 amplifies the transmission signal and outputs the amplified transmission signal to the electromagnetic resonant coupler 100. In addition, the amplifier 213 can amplify or attenuate the transmission signal to thus adjust the amplitude of the transmission signal.

The reception circuit 202 demodulates the transmission signal output from the output terminal 121a included in the electromagnetic resonant coupler 100. The demodulated signal is output to the terminal 210. Specifically, the reception circuit 202 is, but is not particularly limited to, a rectifier circuit that includes a diode, an inductor, and a capacitor.

The reception circuit 202 is die-bonded on the upper surface of the second leadframe 205. The electromagnetic resonant coupler 100 is also die-bonded on the upper surface of the second leadframe 205.

The detection circuit 203 is connected to the terminal 131a and acquires a detection wave corresponding to the transmission signal from the coupling line 130. In addition, the detection circuit 203 generates a detection signal with the use of the detection wave and outputs the generated detection signal to the terminal 207. The terminal 207 is a terminal through which the detection signal is output and that is exposed to the outside of the package member 206. The detection circuit 203 is, for example, a semiconductor formed into a chip and is die-bonded on the upper surface of the first leadframe 204.

Hereinafter, the detailed configuration of the detection circuit 203 will be described. The detection circuit 203 converts a transmission signal, which is a high-frequency signal, to a direct current signal. The detection circuit 203 includes, for example, a single-shunt rectenna circuit. The single-shunt rectenna circuit is capable of power conversion of a high-frequency signal into a direct current signal with high efficiency with a simple configuration. The detection circuit 203 includes a diode 203a, an inductor 203b, and a capacitor 203c.

In the detection circuit 203, the anode of the diode 203a is connected to the ground, and the cathode of the diode 203a is connected to the terminal 131a and one end of the inductor 203b.

The inductor 203b and the capacitor 203c function as a low-pass filter with respect to the fundamental wave of the detection wave. The one end of the inductor 203b is connected to the cathode of the diode 203a and the terminal 131a. The one end of the inductor 203b is connected to the terminal 207 and one end of the capacitor 203c. The capacitor 203c is connected at one end to the terminal 207 and the other end of the inductor 203b and connected at the other end to the ground.

When the diode 203a, the inductor 203b, and the capacitor 203c are connected in this manner, the detection circuit 203 can output a positive direct current voltage to the terminal 207. The detection circuit 203 can output a negative direct current voltage when the cathode of the diode 203a is connected to the ground and the anode of the diode 203a is connected to the terminal 131a and the one end of the inductor 203b. The detection circuit 203 operates as follows.

Upon a detection wave being input to the detection circuit 203, a high-frequency signal of half a cycle in which the detection wave has a positive voltage (hereinafter, also referred to as a positive high-frequency signal) is applied to the diode 203a. At this point, the diode 203a enters an OFF state, and the positive high-frequency signal is thus output to the inductor 203b.

The other end of the capacitor 203c is connected to the ground, and the one end and the other end of the capacitor 203c are short-circuited with respect to the positive high-frequency signal. In other words, the capacitor 203c is the fixed end with respect to the positive high-frequency signal. Thus, the positive high-frequency signal is reflected in a reverse phase at the capacitor 203c, passes through the inductor 203b again, and is output to the diode 203a.

The electric wire length of the inductor 203b is set to approximately one-quarter the wavelength of the fundamental wave of the detection wave. Thus, the positive high-frequency signal that has been reflected at the capacitor 203c and has returned to the diode 203a is delayed by half a cycle and is in a reverse phase upon having gone back and forth through the inductor 203b.

Meanwhile, when a high-frequency signal of another half a cycle in which the detection wave is a negative voltage (hereinafter, also referred to as a negative high-frequency signal) is applied to the diode 203a, the negative high-frequency signal is added, in phase, to the above-described positive high-frequency signal that has been reflected by and has returned from the capacitor 203c. In this case, the diode 203a enters an ON state, and thus the negative high-frequency signal to which the positive high-frequency signal has been added is rectified in a state in which the crest value is higher than that in the case of half-wave rectification. In other words, double voltage rectification is achieved.

In this manner, the detection circuit 203 seems like a half-wave rectifier circuit at a glance but is capable of double voltage rectification, and the conversion efficiency equivalent to that of full-wave rectification can be achieved. The rectified signal is smoothed by the capacitor 203c to result in a detection signal. The detection signal is a direct current signal of which the signal level varies in accordance with the amplitude of the detection wave.

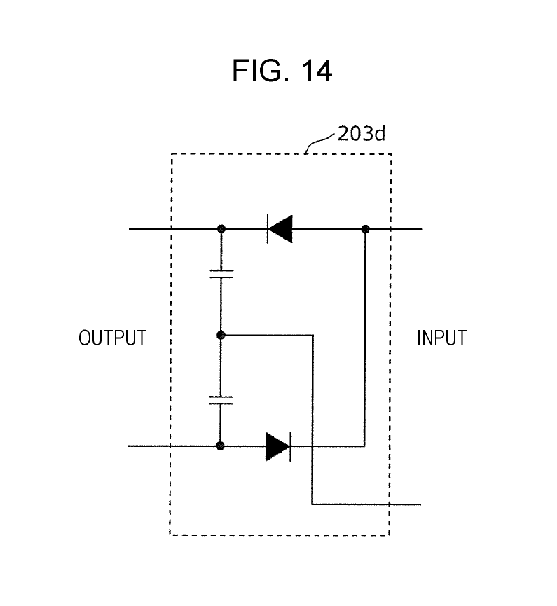

The detection circuit 203 does not need to be such a configuration that includes a single-shunt rectenna circuit. The detection circuit 203 may include a single-series rectenna circuit or may include another rectenna circuit. The transmission apparatus 200 may include, in place of the detection circuit 203, a detection circuit that includes a circuit other than a rectenna circuit, such as a detection circuit 203d that includes a double voltage rectifier circuit as illustrated in FIG. 14. FIG. 14 illustrates a circuit configuration of the detection circuit 203d that includes a double voltage rectifier circuit.

As described thus far, the transmission apparatus 200 can output, through the terminal 207, a detection signal of which the signal level varies in accordance with the amplitude of a detection wave corresponding to a transmission signal. As the transmission circuit 201 is controlled in accordance with the detection signal, the fluctuation in the amplitude of the transmission signal is suppressed. For example, the control is possible that brings the signal level of a signal output from the transmission apparatus close to being constant regardless of the ambient temperature of the transmission apparatus 200. In addition, product inspection, failure analysis, and so on can be carried out with the use of a detection signal.

### First Modification of Third Embodiment

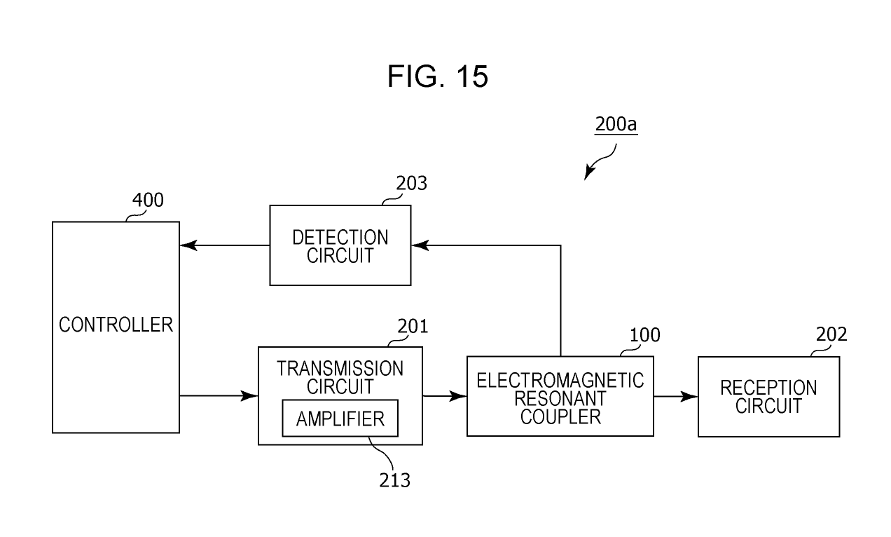

The controller that controls the transmission circuit 201 with the use of the detection signal as described above may be provided externally to the transmission apparatus 200, or the transmission apparatus 200 may include a controller. In other words, the transmission apparatus 200 may be a device formed into a package including a controller. FIGS. 15 through 17 are block diagrams of transmission apparatuses that include a controller.

A transmission apparatus 200a illustrated in FIG. 15 further includes a controller 400 that controls the transmission circuit 201 on the basis of a detection signal output from the detection circuit 203 to thus adjust the transmission signal. Specifically, the controller 400 controls the amplifier 213 on the basis of the output detection signal to thus adjust the amplitude of the transmission signal. The controller 400, for example, raises the gain of the amplifier 213 as the signal level of the detection is lower. This configuration suppresses a variation in the amplitude of the signal output from the transmission apparatus 200a.

The controller 400 is implemented, for example, by a circuit but may instead be implemented by a processor and a memory. A processor, for example, is a central processing unit (CPU), a microprocessing unit (MPU), or the like. In this case, the processor may read out and execute a program stored in the memory to thus control the transmission circuit 201.

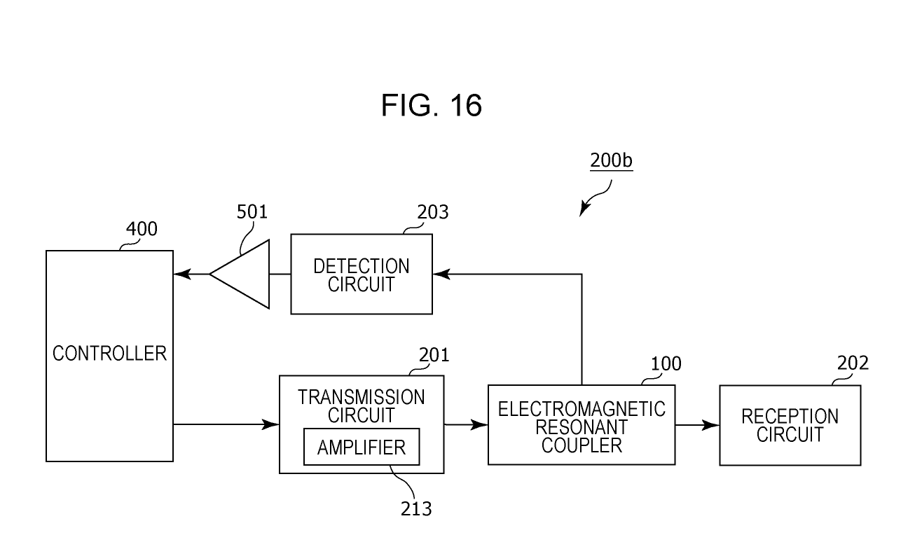

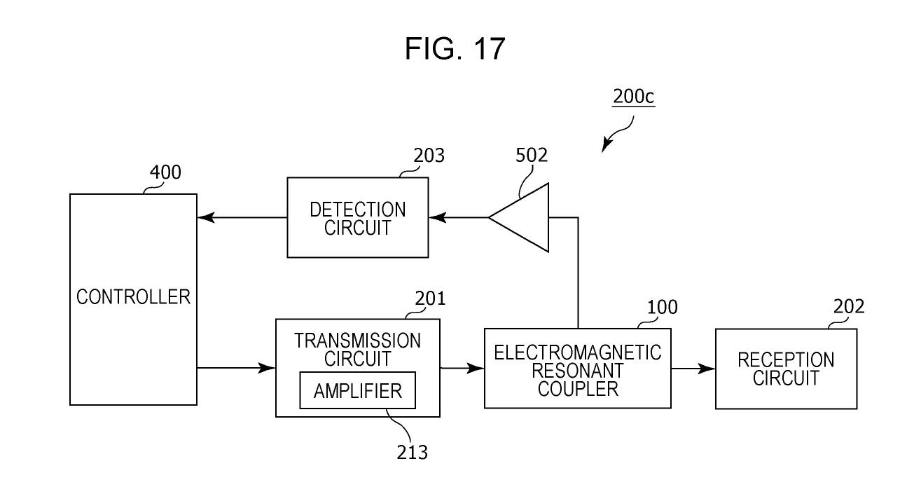

In the case in which the amplitude of a detection wave is small, a transmission apparatus 200b may include an amplifier 501 that amplifies a detection signal output from the detection circuit 203, as illustrated in FIG. 16. Such a transmission apparatus 200b can amplify the detection signal. In addition, as illustrated in FIG. 17, a transmission apparatus 200c may include an amplifier 502 that amplifies a detection wave obtained from the coupling line 130 and outputs the amplified detection wave to the detection circuit 203. Such a transmission apparatus 200c can amplify the detection wave.

### Second Modification of Third Embodiment

For example, when a power switch of large power is driven in a motor driving circuit, a large current is supplied instantaneously to an input terminal of the power switch. Thus, in order to drive a power switch of large power, power is once accumulated in an external capacitor or the like, and the accumulated power is discharged with two or more small-sized switches. Therefore, a transmission apparatus to be used in a motor driving circuit includes two or more pairs of first resonators and second resonators.

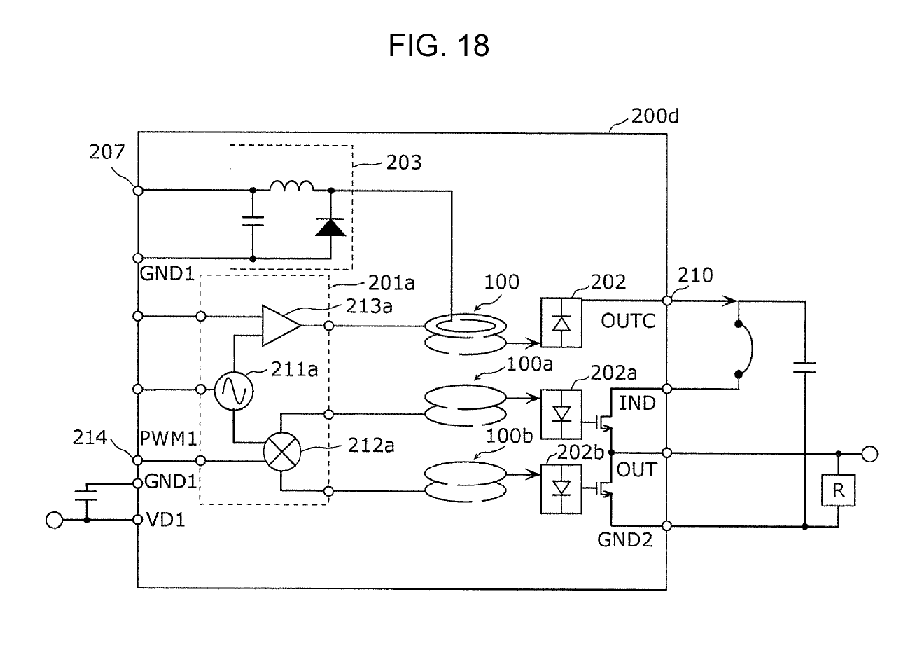

Thus, a transmission apparatus may include two or more electromagnetic resonant couplers. FIG. 18 illustrates a circuit configuration of a transmission apparatus that includes three electromagnetic resonant couplers.

A transmission apparatus 200d illustrated in FIG. 18 includes three electromagnetic resonant couplers. Specifically, the transmission apparatus 200d includes an electromagnetic resonant coupler 100 for adjusting the signal level of a signal output from the transmission apparatus 200d, an electromagnetic resonant coupler 100a for driving a high-side switch, and an electromagnetic resonant coupler 100b for driving a low-side switch. The electromagnetic resonant couplers 100a and 100b have a configuration similar to that of the electromagnetic resonant coupler 100 except in that the electromagnetic resonant couplers 100a and 100b do not include the coupling line 130.

A transmission circuit 201a included in the transmission apparatus 200d includes, for example, an oscillator circuit 211a having two output terminals, a mixing circuit 212a having two output terminals, and an amplifier 213a.

The amplifier 213a amplifies a high-frequency signal output from one of the output terminals of the oscillator circuit 211a and outputs the amplified high-frequency signal to the electromagnetic resonant coupler 100. The mixing circuit 212a modulates a high-frequency signal output from the other one of the output terminals of the oscillator circuit 211a in accordance with an input signal to thus generate a transmission signal and outputs the generated transmission signal to the electromagnetic resonant coupler 100a. In addition, the mixing circuit 212a modulates the high-frequency signal output from the other one of the output terminals of the oscillator circuit 211a in accordance with a signal obtained by inverting the logic of the input signal to thus generate a transmission signal and outputs the generated transmission signal to the electromagnetic resonant coupler 100b.

The transmission signal transmitted by the electromagnetic resonant coupler 100a is received and demodulated by a reception circuit 202a. The transmission signal transmitted by the electromagnetic resonant coupler 100b is received and demodulated by a reception circuit 202b. The reception circuits 202a and 202b are rectifier circuits, for example. For example, a rectifier circuit of which the connection relationship between the anode and the cathode of the diode is reversed from that of the reception circuit 202 is used for the reception circuits 202a and 202b.

In this manner, the transmission apparatus 200d may include a plurality electromagnetic resonant couplers. Similarly to the transmission apparatus 200, the transmission apparatus 200d can output, through the terminal 207, a detection signal of which the signal level varies in accordance with the amplitude of the detection signal corresponding to the transmission signal (high-frequency signal).

Similarly to the transmission apparatus 200a, the transmission apparatus 200d may include a controller. In other words, the transmission apparatus 200d may be a device formed into a package including a controller.

### Advantageous Effects of Third Embodiment

As described thus far, the transmission apparatus 200 includes the electromagnetic resonant coupler 100; the transmission circuit 201 that inputs a transmission signal to the input line 111; and the detection circuit 203 that is connected to the one end portion 131 of the coupling line 130, generates a detection signal with the use of a detection wave obtained from the coupling line 130, and outputs the generated detection signal. The one end portion 131 of the coupling line 130 corresponds to one end of the coupling line 130.

In this manner, the transmission apparatus 200 can output a detection signal corresponding to a transmission signal. The detection signal makes it possible to monitor the transmission signal with ease.

In addition, similarly to the transmission apparatus 200a, the transmission apparatus 200 may further include the controller 400 that controls the transmission circuit 201 on the basis of the output detection signal to thus adjust the transmission signal.

In this manner, as the transmission circuit 201 is controlled in accordance with the detection signal, a fluctuation in the amplitude of the transmission signal is suppressed. For example, the control is possible that brings the signal level of the signal output from the transmission apparatus 200 close to being constant regardless of the ambient temperature of the transmission apparatus 200.

Specifically, the transmission circuit 201 may include the amplifier 213 that adjusts the amplitude of the transmission signal, and the controller 400 may control the amplifier 213 on the basis of the output detection signal to thus adjust the amplitude of the transmission signal.

In this manner, as the amplifier 213 is controlled in accordance with the detection signal, a fluctuation in the amplitude of the transmission signal is suppressed. For example, the control is possible that brings the signal level of the signal output from the transmission apparatus 200 close to being constant regardless of the ambient temperature of the transmission apparatus 200.

The detection circuit 203 may include a rectenna circuit.

This configuration enables the detection circuit 203 to generate the detection signal by using the rectenna circuit.

Similarly to the detection circuit 203d, the detection circuit 203 may include a double voltage rectifier circuit.

This configuration enables the detection circuit 203d to generate the detection signal by using the double voltage rectifier circuit.

Similarly to the transmission apparatus 200c, the transmission apparatus 200 may further include the amplifier 502 that amplifies the detection wave obtained from the coupling line 130 and outputs the amplified detection wave to the detection circuit 203.

This configuration enables the transmission apparatus 200c to amplify the detection wave.

Similarly to the transmission apparatus 200b, the transmission apparatus 200 may further include the amplifier 501 that amplifies the detection signal output from the detection circuit 203.

This configuration enables the transmission apparatus 200b to amplify the detection signal.

The transmission apparatus 200 may further include the package member 206 that seals the electromagnetic resonant coupler 100, the transmission circuit 201, and the detection circuit 203; and the terminal 207 through which the detection signal is output and that is exposed through the package member 206.

This configuration makes it possible to monitor the transmission signal with ease through the terminal 207.

### Other Embodiments

As described thus far, the embodiments have been described to illustrate the techniques disclosed in the present application. However, the present disclosure is not limited to these embodiments and can also be applied to other embodiments that include modifications, replacements, additions, omissions, and so on, as appropriate. In addition, a new embodiment can also be conceived of by combining the constituent elements described in the above embodiments.

For example, the circuit configurations described in the first through third embodiments above are merely examples. A different circuit configuration that can implement the functions described in the above first through third embodiments may instead be used. For example, a circuit configuration in which an element such as a switching element, a resistive element, or a capacitative element is connected in series or in parallel to another element within the scope in which the functions similar to those of the circuit configurations described above can be achieved is also included within the present disclosure. In other words, the term “connected” as used in the embodiments described above is not limited to the case in which two terminals (nodes) are connected directly but includes the case in which such two terminals (nodes) are connected with another element interposed therebetween within the scope in which a similar function can be achieved.

General or specific embodiments of the present disclosure may be implemented in the form of a system, a method, an integrated circuit, a computer program, or a computer-readable recording medium, such as a CD-ROM. General or specific embodiments of the present disclosure may be implemented through any desired combination of a system, a method, an integrated circuit, a computer program, and a recording medium. For example, the present disclosure may be implemented in the form of a method of adjusting a signal output by a transmission apparatus and a program for causing a computer to execute such a method.

Thus far, an electromagnetic resonant coupler and a transmission apparatus according to one or a plurality of aspects have been described on the basis of the embodiments, but the present disclosure is not limited to these embodiments. Unless departing from the spirit of the present disclosure, an embodiment obtained by making various modifications that are conceivable by a person skilled in the art to the present embodiments or an embodiment obtained by combining the constituent elements in different embodiments may also be included within the scope of the one or the plurality of aspects.

What is claimed is:

1. An electromagnetic resonant coupler, comprising:
an input line to which a transmission signal is input;
a first resonance line connected to the input line;
a second resonance line opposing the first resonance line, the second resonance line undergoing resonant coupling with the first resonance line to thus wirelessly transmit the transmission signal between the first resonance line and the second resonance line;
an output line connected to the second resonance line, the transmission signal being output through the output line;
a coupling line that electromagnetically couples with at least one selected from the group consisting of the first resonance line and the second resonance line; and
a terminator connected to one end of the coupling line.

2. The electromagnetic resonant coupler according to claim 1, wherein:
the first resonance line and the coupling line are disposed in a plane,
the second resonance line opposes the first resonance line in a direction intersecting with the plane, and
the coupling line is disposed along a portion of the first resonance line with a gap provided between the coupling line and the portion of the first resonance line to thus couple with the first resonance line.

3. The electromagnetic resonant coupler according to claim 2, wherein:
the first resonance line has an annular shape with a portion of the annular shape being open, and
the coupling line is disposed inside the first resonance line in the plane.

4. The electromagnetic resonant coupler according to claim 2, wherein:
the first resonance line has an annular shape with a portion of the annular shape being open, and
the coupling line is disposed outside the first resonance line in the plane.

5. A transmission apparatus, comprising:
an electromagnetic resonant coupler including
an input line to which a transmission signal is input,
a first resonance line connected to the input line,
a second resonance line opposing the first resonance line, the second resonant line undergoing resonant coupling with the first resonance line to thus wirelessly transmit the transmission signal between the first resonance line and the second resonance line,
an output line connected to the second resonance line, the transmission signal being output through the output line,
a coupling line that electromagnetically couples with at least one selected from the group consisting of the first resonance line and the second resonance line and that outputs a detection wave corresponding to the transmission signal, and
a terminator connected to one end of the coupling line;
a transmission circuit that inputs the transmission signal to the input line; and
a detection circuit connected to another end of the coupling line, the detection circuit generating a detection signal by using the detection wave and outputting the detection signal.

6. The transmission apparatus according to claim 5, further comprising:
a controller that controls the transmission circuit on the basis of the detection signal to thus adjust at least one selected from the group consisting of an amplitude of the transmission signal and a frequency of the transmission signal.

7. The transmission apparatus according to claim 6, wherein:
the transmission circuit further includes an amplifier that adjusts the amplitude of the transmission signal, and
the controller controls the amplifier on the basis of the detection signal to thus adjust the amplitude of the transmission signal.

8. The transmission apparatus according to claim 5,
wherein the detection circuit includes a rectenna circuit.

9. The transmission apparatus according to claim 5,
wherein the detection circuit include a double voltage rectifier circuit.

10. The transmission apparatus according to claim 5, further comprising:
an amplifier that amplifies the detection wave and outputs the detection wave to the detection circuit.

11. The transmission apparatus according to claim 5, further comprising:
an amplifier that amplifies the detection signal output by the detection circuit.

12. The transmission apparatus according to claim 5, further comprising:
a package member that seals the electromagnetic resonant coupler, the transmission circuit, and the detection circuit; and
a terminal that is partially exposed through the package member, the detection signal being output through the terminal.
